(19) United States
(12) Patent Application Publication
(10) Pub. No.: US 2022/0268313 A1
(43) Pub. Date: Aug. 25, 2022

(54) LOCKING SHAFT SPACER ASSEMBLY AND METHOD

(71) Applicant: Kinkisharyo International LLC, El Segundo, CA (US)

(72) Inventor: Larry J. Conrad, Smicksburg, PA (US)

(21) Appl. No.: 17/179,796

(22) Filed: Feb. 19, 2021

(51) Int. Cl. F16C 19/54; F16C 35/063; F16C 35/07

(52) U.S. Cl. CPC F16C 19/548; F16C 35/063; F16C 35/07; F16C 2326/02

(57) ABSTRACT

A locking spacer assembly for mounting on an elongated member and a method of use thereof are disclosed. A first element with a first end and a second end fits over the elongated member with the first end, which may be beveled, facing outwards. A second element with a beveled end fits over the elongated member with the beveled end facing inwards toward the beveled end of the first element. Finally, a flexible member fits over the elongated member between the first element and the second element. The flexible member has a cross-section selected to be compressed and fit within a space formed when the first element and second element are compressed together on the elongated member so that the compression of the flexible member secures the locking spacer assembly to the elongated member so long as the compression is maintained.

### FIELD

This disclosure relates generally to a locking shaft spacer assembly and method, and more particularly to a locking shaft spacer for a shaft, e.g., a railway car wheel axle, that minimizes wear over time and a method of use thereof.

### BACKGROUND

Mechanical spacers are commonly used in many different applications, including gearing transmissions, bearings assemblies, and railway axle assemblies. These mechanical spacers are typically used to position components to a desired location on a shaft. Such spacers commonly have an inner diameter that allows for a sliding fit onto the shaft for ease of assembly.

FIG. 1 shows as an example an assembly 100 of how conventional mechanical spacers, i.e., spacers 120, 130, are used to position components (such as bearing assembly 140 and steel wheel 150) linearly on an axle shaft 110 having an axle centerline 118 and a stepped portion 115. Stepped portion 115 is a squared transition from a smaller diameter to a larger diameter. Axle shaft 110 includes a step at stepped portion 115, transitioning from a smaller diameter to the left of stepped portion 115 to a larger diameter to the right of stepped portion 115. Each spacer 120, 130 is cylindrical with predetermined inner and outer diameters, and a predetermined width (i.e., the height of the cylinder). The inner diameter is chosen based on the diameter of the shaft upon which it is to be fitted. The outer diameter is chosen to provide an appropriate level of mechanical stability and/or surface contact when mating with components such bearing, shoulders, or seals. The width is chosen for proper spacing. In FIG. 1, spacer 130 has a width 131 that sets the position of the bearing assembly 140 on the axle shaft 110 by fixing the distance from the stepped portion 115. The bearing assembly 140 has a fixed width 141 and thus spacer 120 has a width 121 that, in combination with the widths 141, 131 of bearing assembly 140 and spacer 130, sets the location of the steel wheel 150. The steel wheel 150 is press-fit onto axle shaft 110. This press-fit construction keeps the steel wheel 150 from moving on the axle shaft 110 and also keeps the spacer 120, the bearing assembly 140, and the spacer 130 pushed tightly together so that spacers 120, 130 rotate together with steel wheel 150 and axle shaft 110 in operation.

A problem with the assembly 100 shown in FIG. 1 is that, over time, a number of external forces act on the assembly 100 to loosen the spacing among the parts to the extent that the spacers 120, 130 may no longer rotate together with the axle shaft 110. These forces include, inter alia, grease seal friction, vibration, and thermal expansion and contraction. When spacers 120, 130 no longer rotate with axle shaft 110, the frictional movement between and among the parts, including axle shaft, 110, spacers 120, 130, bearing assembly 140, and steel wheel 150 can increase the wear in these parts. This wear can further loosen the spacing among the parts and increase the rate of wear over time significantly. As a result of this type of wear, the entire assembly 100 may need to be either replaced or the axles and/or spacers may need to be machined to eliminate any imperfections caused by the wear and to ensure that the spacers have an interference fit to reduce future wear. This process can be quite costly.

Traditional spacers such as those shown in FIG. 1 can freely move on a shaft to allow for ease of assembly and disassembly, but have certain drawbacks as discussed above. Accordingly, there is a need for a spacer assembly which is secured to the shaft after final assembly to overcome those drawbacks.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a drawing of a cross-sectional view of a railway car wheel axle assembly using a prior art spacer;

FIG. 2A is a cross-sectional view of a first embodiment of a locking spacer assembly according to the present disclosure;

FIG. 2B is a cross-sectional view of a second embodiment of a locking spacer assembly according to the present disclosure;

FIG. 2C is a cross-sectional view of a third embodiment of a locking spacer assembly according to the present disclosure;

FIG. 2D is a cross-sectional view of a fourth embodiment of a locking spacer assembly according to the present disclosure.

FIG. 3 is a detailed cross-sectional view of the locking spacer assembly showing the forces generated after installation; and

FIG. 4 is a cross-sectional view of a railway car wheel axle assembly using the locking spacer assembly of the present disclosure.

### DETAILED DESCRIPTION

In the present disclosure, like reference numbers refer to like elements throughout the drawings, which illustrate various exemplary embodiments of the present disclosure.

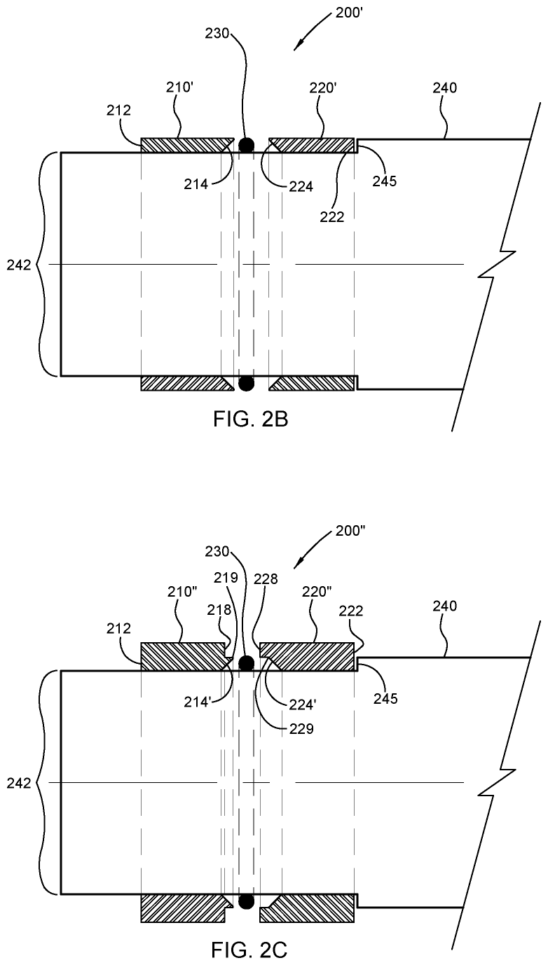

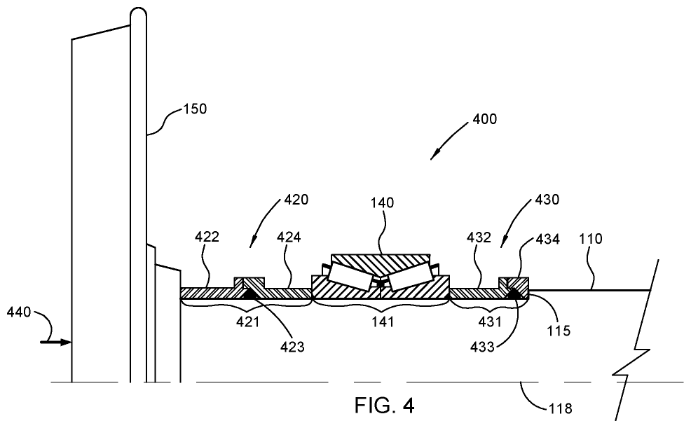

Referring now to FIG. 2A, a locking spacer assembly 200 is shown which has a first element 210, a second element 220, and a flexible member 230 mounted on an area of an elongated member such as a shaft 240 having a step 245. As will generally be understood by those skilled in the art, the locking shaft assembly disclosed herein may be used in any machine or device that employs an elongated member such as a rotating shaft, including, but not limited to construction equipment, railway vehicles, power trains, on and off-road vehicles, transmissions, machine components, mining equipment, farming equipment, milling machines, aircraft, marine drives, spacecraft, conveyor rolls, and windmills, among others. Shaft 240 has circular cross-section in the area with a predetermined diameter 242 where locking spacer assembly is to be positioned. Locking spacer assembly 200 locks onto a shaft 240 in order to prevent both rotational movement and linear movement with respect to shaft 240. This ensures that frictional wear to the shaft 240, locking spacer assembly 200, and any components directly adjacent to locking spacer assembly 200 is greatly minimized or even eliminated entirely. The first element 210 has a cylindrical shape with a first end 212, a second end 214 (or beveled end 214), and an annular upward extension 216. The annular upward extension 216 is annular in form and has an outer edge 217. The second end 214 is beveled so that an inner surface of the first element 210 (the surface in contact with the shaft) has a narrower length than an outer surface thereof. The second element 220 has a cylindrical shape with a first end 222, a second end 224 (or beveled end 224), and an annular upward extension 226. The annular upward extension 226 is annular in form and has an outer edge 227. The second end 224 is beveled so that an inner surface of the second element 220 (the surface in contact with the shaft) has a narrower length than an outer surface thereof. When the first element 210 and the second element 220 are pressed together on the shaft 240, the annular upward extension 216 acts as a stop for the annular upward extension 226 of second element 220 (as shown in FIG. 4 discussed below), thereby accurately controlling the installed width of the locking spacer assembly 200.

In one alternative embodiment of the assembly 200′ shown in FIG. 2B, each annular upward extension 216, 226 may be omitted from the two elements 210′ and 220′ and the outward tips of the second ends 214, 224 may act as the stop to set the width of the locking spacer assembly 200′.

In another alternative embodiment shown of the assembly 200″ in FIG. 2C, the entire width of first element 210″ and second element 220″ may have a height that matches the height of the annular upward extension 216 and annular upward extension 226 in FIG. 2A. For assembly 200″, the right side of first element 210″ has a lower end portion 214′ (also called a lower beveled portion 214′) that may be beveled as in the FIG. 2A embodiment or may be squared as in the FIG. 2D embodiment and an upper end portion 218 having a squared outer edge. In addition, the left side of second element 220 has a lower end portion 224′ (also called a lower beveled portion 224′) that is beveled as in the FIG. 2A embodiment and an upper end portion 228 with a squared outer edge. In the FIG. 2C embodiment, the two upper end portions 218, 228 fit together to form a stop, as in the FIG. 2A embodiment, while the lower end portion 214′ and the lower end portion 224′ form the space for flexible member 230. Further, the first element 210″ and second element 220″ each have an outer lateral point 219, 229 for the lower end portion 214′, 224′, respectively, at the top point of the beveled (or alternatively squared for lower end portion 214′) surface.

In all of the embodiments, the flexible member 230 is preferably an O-ring formed from an appropriate elastomer compound but may alternately be an appropriately sized rubber washer, a pliable material such as steel, aluminum, brass, copper, or woven composite material, other polymer compounds (e.g., nylon), conventional packing seals, or the like. The flexible member 230 has an inner diameter that matches the diameter 242 of the shaft 240 and a cross-sectional area (cross-sectional diameter when flexible member 230 is an O-ring) that chosen based on the type of material selected for flexible member 230 and the space that exists between the second ends 214, 224 when the first element 210 is pressed tightly against the second element 220. For example, when the flexible member 230 is formed from a compressible material such as an elastomer or rubber, the cross-sectional area of flexible member 230 may be slightly larger than the space that exists between the second ends 214, 224 when the first element 210 is pressed tightly against the second element 220. In contrast, when the flexible member 230 is formed from a pliable material such as steel, aluminum, brass, copper, or woven composite material, the cross-sectional area of flexible member 230 may be slightly smaller than the space that exists between the second ends 214, 224 when the first element 210 is pressed tightly against the second element 220. The cross-section of the flexible member may be oval, round, triangular, square, or rectangular, depending on the type of material selected and the amount of locking force to be generated by the flexible member 230 after installation of the locking shaft assembly.

In yet another alternative embodiment of the assembly 200′″ shown in FIG. 2D, the first element 210′″ has a cylindrical shape with a first end 212, a second end 214′″ that is not beveled, and an optional annular upward extension 216. In this embodiment, the flexible member 230 fits into a space formed between the non-beveled end 214′″ of first element 210′″ and the beveled end 224 of second element 220. The second element 220 has a cylindrical shape with a first end 222, a second end 224 (or beveled end 224), and an optional annular upward extension 226.

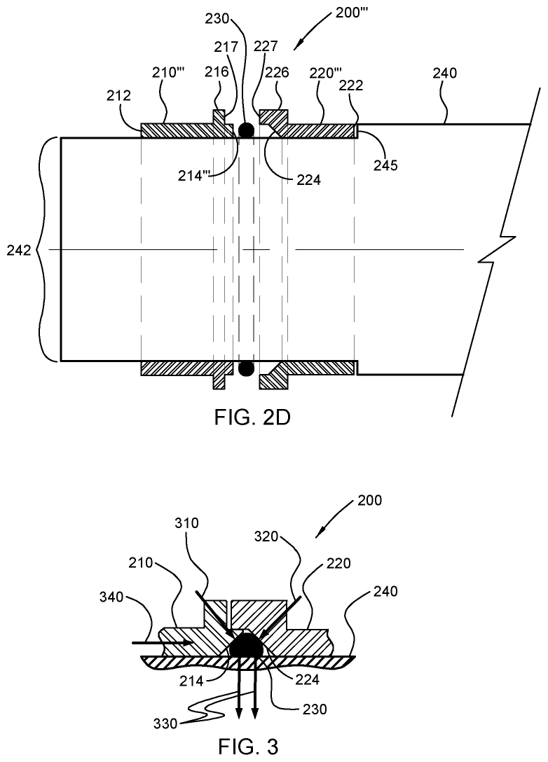

Referring now to FIG. 3, because the flexible member 230 is slightly larger than the space between the second end 214 of first element 210 and the second end 224 of second element 220, as the first element 210 is pressed against second element 220 (shown by vector 340), forces (shown by vectors 310 and 320) will compress the flexible member 230 and produce downward forces (shown by vectors 330) on the shaft 240. So long as an adequate linear force is maintained keeping the first element 210 pressed against second element 220, the locking spacer assembly 200 will become locked in position and resist linear and rotational movement with respect to the shaft 240. Note that the vector 340 demonstrates the pressure provided when the second element 220 is fixed in position, as shown in FIG. 2A where the first end 222 of the second element 220 is pressed tightly against step 245 of shaft 240. In other applications, the first end 212 of the first element 210 may instead be fixed in position and the forces applied to compress flexible member 230 may arise from a direction opposite from vectors 330 as the second element 220 is pressed into first element 210.

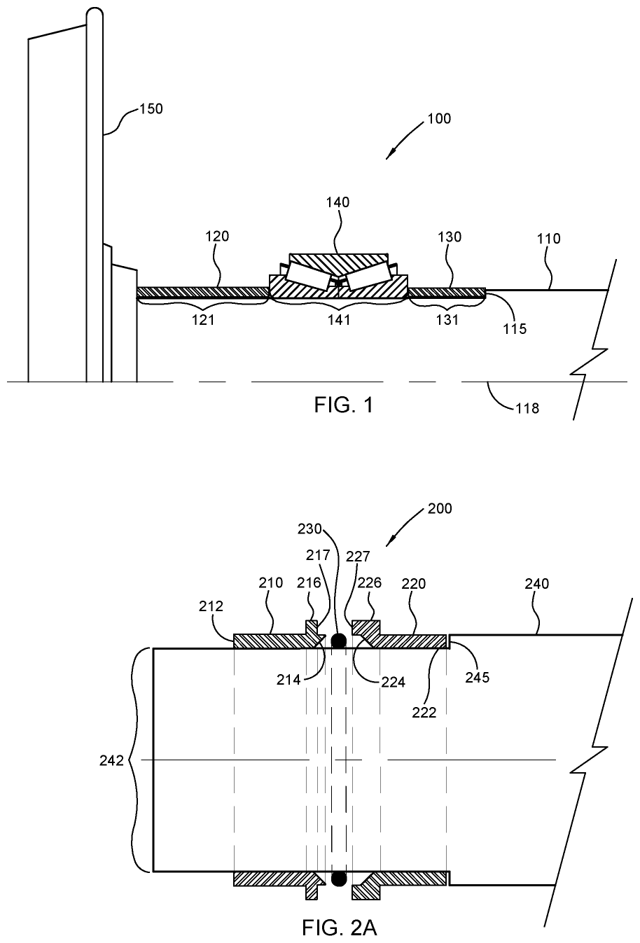

The cross-sectional size and composition of flexible member 230 is chosen so that enough downward force is generated after the installation of locking spacer assembly 200 on the shaft 240 that locking spacer assembly 200 will maintain its locked position on the shaft 240 over time, even as the original press-fit assembly tolerances loosen slightly due to, e.g., vibration and thermal contacting/expansion and as the assembly accumulates grease and other contaminates. Unlike the prior art spacers shown in FIG. 1, the locking spacer assembly 200 of the present disclosure does not rely on a close fit between the inner surface thereof and the outer surface of the shaft 240 to maintain position. Instead, the locking spacer assembly 200 generates downward forces onto shaft 240 via the compression of flexible member 230, as discussed above. This approach provides a very significant benefit over the prior art spacers as there is no need to machine or replace the axle itself when refurbishing an assembly by upgrading the assembly to use the locking spacer assembly 200 of this disclosure. This is because locking spacer assembly 200 effectively compensates for any surface imperfections and irregularities of the shaft 240 in regards to diameter 242 (as may be caused by wear) since the flexible member 230 does not require a smooth surface to allow the locking spacer assembly 200 to become locked to the shaft 240. In particular, the flexible makeup of the compound used to form flexible member 230 actually compensates for any surface imperfections and irregularities of shaft 240. This benefit can provide significant cost savings in renewing or refurbishing worn axle assemblies.

Referring now to FIG. 4, an example installation 400 is shown in which two locking spacer assemblies 420, 430 are used instead of the conventional spacers shown in the FIG. 1 prior art example. The locking spacer assembly 430 has a right element 434 that is positioned against the stepped portion 115 in axle shaft 110, a flexible member 433, and a left element 432. Locking spacer assembly 430 provides a fixed spacing having a width 431 upon installation. The right element 434 in FIG. 4 has a smaller width that the left element 432. In other applications, the left element 432 and the right element 434 may be evenly sized. The locking spacer assembly 420 has a right element 424 that is positioned against the left side of bearing assembly 140, a flexible member 423, and a left element 422. Locking spacer assembly 420 provides a fixed spacing having a width 421 upon installation. When the steel wheel 150 is press fit onto an outer portion of axle shaft 110, the two flexible members 423, 433 will compress due to the lateral force in the direction of vector 440 and lock the respective locking spacer assembles (i.e., locking spacer assembly 420 and locking spacer assembly 430) onto axle shaft 110. The steel wheel 150 will be positioned on axle shaft 110 at a positon set by the widths 421, 431 of the two locking spacer assemblies and the width of the bearing assembly 140. Note that steel wheel 150 may be mounted to axle shaft 110 in other ways, e.g., via threads on the end of axle shaft 110 or a fastener mounted into a threaded apertures on the end of axle shaft 110. When steel wheel 150 is mounted in this alternative way, steel wheel 150 also provides lateral forces in the direction of vector 440 causing the two flexible members 423, 433 to compress and lock the two locking spacer assemblies 420, 430 to the axle shaft 110. This ability to lock the locking spacer assemblies 420, 430 to the axle shaft 110 in this manner prevents any rotational movement of the locking spacer assemblies 420, 430 with respect to the axle shaft 110 and greatly reduces wear over time. In either mounting method, the steel wheel 150 will be positioned on axle shaft 110 at a positon set by the sum of the width 421 of locking spacer assembly 420, the width 431 of the locking spacer assembly 430, and the width 141 of the bearing assembly 140. The example installation 400 shown in FIG. 4 shows the use of two locking spacer assemblies 420, 430 used to provide spacing on an axle shaft 110 for two components, i.e., bearing assembly 140 and steel wheel. As will generally be understood by those skilled in the art, the two components shown in FIG. 4 are merely exemplary and the steel wheel 150 may be replaced by any component used to provide an axial force to hold components on shaft, e.g., a sprocket, gear, bearing, or mounting hardware alone.

Although the present disclosure has been particularly shown and described with reference to the preferred embodiments and various aspects thereof, it will be appreciated by those of ordinary skill in the art that various changes and modifications may be made without departing from the spirit and scope of the disclosure. In particular, although the preferred embodiments disclosed above are addressed to a locking spacer assembly for a shaft having a round cross-section, according to the spirit and scope of the present disclosure, the locking spacer assembly can be formed to provide a fixed, locked spacer on a shaft of any cross-section, round, oval, square, rectangular, etc., on which it is desired to fit a spacer in a fixed position over time. It is intended that the appended claims be interpreted as including the embodiments described herein, the alternatives mentioned above, and all equivalents thereto.

1. A locking spacer assembly for mounting on an elongated member, comprising:
a first element adapted to fit over the elongated member, the first element having a first end and a second end;
a second element adapted to fit over the elongated member, the second element having a beveled end so that an inner surface of the second element has a narrower length than a length of an outer surface thereof; and
a flexible member adapted to fit over the elongated member, the flexible member having a cross-section selected to be compressed and fill a space formed when the first element and second element are positioned on the elongated member with the first end of the first element positioned adjacent to the beveled end of the second element and the first element is pressed and held against the second element.

2. The locking spacer assembly of claim 1, wherein the first end of the first element is beveled so that an inner surface of the first element has a narrower length than a length of an outer surface thereof.

3. The locking spacer assembly of claim 2, wherein the elongated member has a circular cross-section with a predetermined diameter in an area where the locking spacer assembly is to be positioned.

4. The locking spacer assembly of claim 3, wherein the first element and the second element each has a cylindrical shape with an inner diameter adapted to fit onto the elongated member.

5. The locking spacer assembly of claim 4, wherein the first element comprises an annular upward extension adjacent to the beveled end thereof.

6. The locking spacer assembly of claim 5, wherein the second element comprises an annular upward extension adjacent to the beveled end thereof.

7. The locking spacer assembly of claim 6, wherein the annular upward extension of the first element has an outer edge adapted to meet an outer edge of the annular upward extension of the second element when the beveled end of the first element is pressed against the beveled end of the second element in order to set a width of locking spacer assembly.

8. The locking spacer assembly of claim 6 wherein the annular upward extension of the first element is positioned inward from an outer edge of the beveled end of the first element and wherein the annular upward extension of the second element extends laterally beyond an outer edge of the beveled end of the second element.

9. The locking spacer assembly of claim 8, wherein the annular upward extension of the first element has an outer edge adapted to meet an outer edge of the annular upward extension of the second element when the beveled end of the first element is pressed against the beveled end of the second element in order to set a width of locking spacer assembly.

10. The locking spacer assembly of claim 3, wherein the flexible member is an O-ring formed from an elastomer compound.

11. A locking spacer assembly for mounting on an elongated member, comprising:
a first element adapted to fit over the elongated member, the first element having a first end with a lower portion and an upper end portion
a second element adapted to fit over the elongated member, the second element having a first end with a lower beveled portion and an upper end portion, the lower beveled portion of the second element formed so that an inner surface of the second element has a narrower length than a length of the second element at an outer lateral point of the lower beveled portion; and
a flexible member adapted to fit over the elongated member, the flexible member having a cross-section selected to be compressed and fill a space formed when the first element and second element are positioned on the elongated member with the first end of the first element positioned adjacent to the first end of the second element and the first element is pressed and held against the second element.

12. The locking spacer assembly of claim 11, wherein the lower portion of the first element is beveled so that an inner surface of the first element has a narrower length than a length of the first element at an outer lateral point of the lower portion.

13. The locking spacer assembly of claim 12, wherein the elongated member has a circular cross-section with a predetermined diameter in an area where the locking spacer assembly is to be positioned.

14. The locking spacer assembly of claim 13, wherein the first element and the second element each has a cylindrical shape with an inner diameter adapted to fit onto the elongated member.

15. The locking spacer assembly of claim 14, wherein the upper end portion of the first end of the first element has an outer edge adapted to meet an outer edge of the upper end portion of the first end of the second element when the first end of the first element is pressed against the first end of the second element in order to set a width of locking spacer assembly.

16. The locking spacer assembly of claim 15, wherein the outer edge of the upper end portion of the first end of the first element is positioned inward from the outer lateral point of the lower beveled portion of the first element and wherein the outer edge of the upper end portion of the first end of the second element extends laterally beyond the outer lateral point of the lower beveled portion of the second element.

17. The locking spacer assembly of claim 16, wherein the outer edge of the upper end portion of the first end of the first element is adapted to meet the outer edge of the upper end portion of the first end of the second element when the first end of the first element is pressed against the first end of the second element to set a width of the locking spacer assembly.

18. The locking spacer assembly of claim 13, wherein the flexible member is an O-ring formed from an elastomer compound.

19. A method of providing a locking spacer assembly on an elongated member between a first part and a second part, comprising:
installing a first element over the elongated member and against the first part, the first element having a first end facing outward on the elongated member;
installing a flexible member over the elongated member and positioning the flexible member against the first end of the first element;
installing a second element over the elongated member, the second element having a beveled end so that an inner surface of the second element has a narrower length than a length of an outer surface thereof, the beveled end facing inward on the elongated member;
pressing the second element linearly inward against the first element so that the flexible member is compressed to fill a space formed between the beveled end of the first element and the beveled end of the second element; and
securely installing the second part on the elongated member against the second element.

20. The method of claim 19, wherein the first end of the first element is beveled so that an inner surface of the first element has a narrower length than a length of an outer surface thereof.
